(19) United States
(12) Patent Application Publication
(10) Pub. No.: US 2015/0072096 A1
(43) Pub. Date: Mar. 12, 2015

(54) SELF-ADHESIVE DECORATIVE MATERIAL CAPABLE OF ATTACHMENT THEREOF TO WALL FACE

(71) Applicant: GOW-TEN CHIEN, New Taipei City (TW)

(72) Inventor: GOW-TEN CHIEN, New Taipei City (TW)

(21) Appl. No.: 14/024,608

(22) Filed: Sep. 11, 2013

(51) Int. Cl. E04F 13/08; B32B 37/14

(52) U.S. Cl. CPC E04F 13/0871; B32B 37/14
USPC 428/41.7; 156/78

(57) ABSTRACT

The present invention prooses a self-adhesive decorative material capable of attachment thereof to a wall face, formed by the following steps: spreading chemical size on a sheet substrate such as wall cloth or wall paper, allowing said chemical size to form a foamed adhesive layer by means of mechanical foaming; and covering a thin film protection layer on the foamed adhesive layer, whereby, upon an attachment work, the self-adhesive decorative material is attached to a wall face after said thin film is torn off therefrom; a repeated attachment is possible if the attachment work is not good enough, allowing the attachment work to be more convenient; the attached self-adhesive decorative material is air-dried naturally and difficult to become wet through ventilation formed by proper gaps existing in the foamed adhesive layer; no size remains on the wall face after the repeatedly usable self-adhesive decorative material is torn off therefrom

### (A) TECHNICAL FIELD OF THE INVENTION

The present invention relates to a self-adhesive decorative material capable of attachment thereof to a wall face, and more particularly to a self-adhesive decorative material capable of attachment thereof to a wall face, easy to be attached to a wall face, and formed with ventilation, thereby achieving the effects of natural air drying and difficulty to wet, remaining no size on a wall face after the decorative material is torn off therefrom, and allowing the torn-off decorative material to be used repeatedly.

### (B) DESCRIPTION OF THE PRIOR ART

Conventional wall cloth or wall paper is adapted to attach to a wall face to have a decoration effect. Upon an attachment work, wall cloth or wall paper is attached to a wall face after a proper amount of size is first spread on the wall face. Such kind of conventional attachment work is high in cost due to complicated work procedures and consumptive work hours. Additionally, there is wall cloth or wall paper with backing adhesive which can be attached to a wall face directly after a protection layer is simply torn off from it while an attachment work is carried out; although it omits a troublesome size spreading on a wall face, wall cloth or wall paper is unable to be detached down and attached on the wall face again if the wall cloth or wall paper is attached to the wall face crookedly or unevenly, and a only thing can be done is to discard it as junk, leading to increase material cost. Moreover, conventional wall cloth or wall paper is not allowed to ventilate at all after the size dries off not matter that it is attached to a wall face by means of size spreading or backing adhesive such that a wetting phenomenon is yielded easily, and a use life of the wall cloth or wall paper is relatively decreased.

### SUMMARY OF THE INVENTION

To improve the deficits mentioned above, and allow an attachment work of wall cloth or wall paper to be more convenient, the present invention is proposed.

The main object of the present invention is to provide a self-adhesive decorative material capable of attachment thereof to a wall face, allowing a decorative material such as wall cloth or wall paper to be more convenient for an attachment work, capable of ventilation so as to achieve the effects of natural air drying and difficulty to become wet, remaining no size on a wall face after the self-adhesive decorative material is torn off therefrom, and allowing the torn-off decorative material to be used repeatedly. Furthermore, customization of the present invention is available and the decorative material of the present invention can be cut into a variety of shapes so as to allow it to be attached to a wall face or article by means of DIY(do it yourself) mosaic.

To achieve the object mentioned above, the present invention proposes a self-adhesive decorative material capable of attachment thereof to a wall face, formed by the following steps: spreading chemical size on a sheet substrate such as wall cloth or wall paper, allowing said chemical size to form a foamed adhesive layer by means of mechanical foaming; and covering a thin film protection layer on the foamed adhesive layer, whereby, upon an attachment work, the self-adhesive decorative material is attached to a wall face after said thin film is torn off therefrom; a repeated attachment is possible if the attachment work is not good enough, allowing the attachment work to be more convenient; the attached self-adhesive decorative material is air-dried naturally and difficult to become wet through ventilation formed by proper gaps existing in the foamed adhesive layer; no size remains on the wall face after the self-adhesive decorative material is torn off therefrom; the torn-off self-adhesive decorative material may be used repeatedly; furthermore, customization is available for the self-adhesive decorative material or the self-adhesive decorative material can be cut into various shapes so as to attach to a wall face or an article by means of DIY mosaic.

### BRIEF DESCRIPTION OF THE DRAWINGS

FIG. 1 is a schematic view of the present invention in a size spreading state;

FIG. 2 is a schematic view of the present invention in a foaming state;

FIG. 3 is a schematic view of the present invention in a thin film protection layer attaching state;

FIG. 4 is a perspective view of a self-adhesive decorative material of the present invention;

FIG. 5 is a schematic view of a plant for making a self-adhesive decorative material according to the present invention; and

FIG. 6 is a schematic view of the present invention attached to a wall face.

### DETAILED DESCRIPTION OF THE PREFERRED EMBODIMENTS

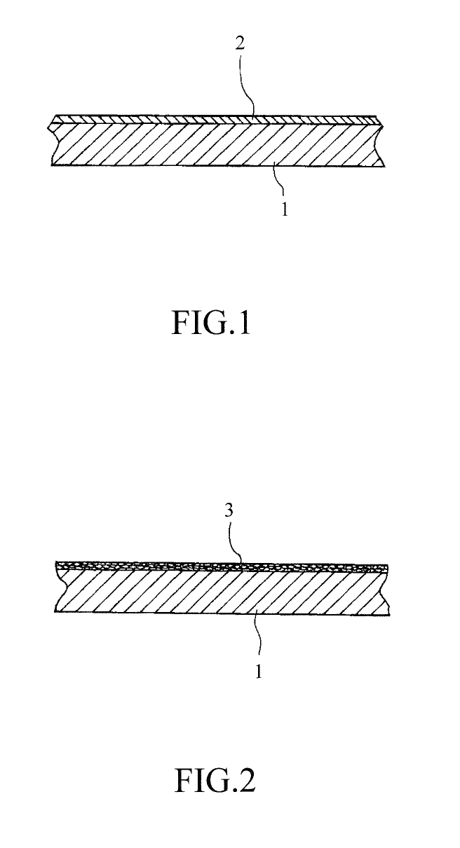

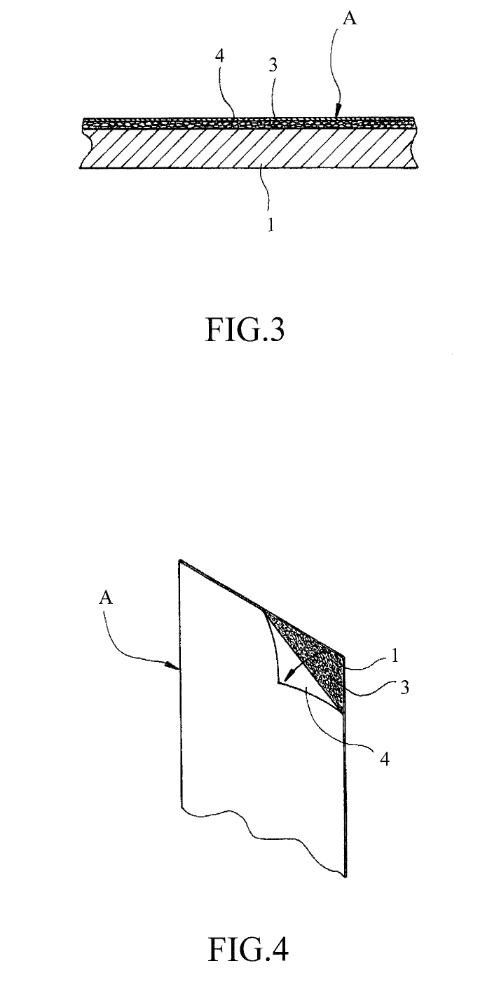

Referring to FIGS. 1, 2 and 3, which respectively schematic views of the present invention on which size is spread, on which foam is formed and to which a thin film is attached for protection. As shown by the figures, a manufacturing method of the present invention mainly includes the following steps:

1. spreading chemical size on a roll of sheet substrate 1 such as cloth or paper, where the sheet substrate 1 may be unwoven cloth, chemical fiber or paper, and the chemical size is propyl acid resin;

2. forming the spread chemical size 2 on the sheet substrate 1 into a foamed adhesive layer by means of mechanical foaming; and

3. covering the foamed adhesive layer with a thin film protection layer to form a roll of self-adhesive decorative material A of a proper dimension.

Whereby, the decorative material A is attached to a wall face through the foamed adhesive layer after the thin film protection layer 4 is torn off. Furthermore, an attachment work of a decorative material A such as wall cloth or wall paper to a wall face can be done repeatedly if it is not good enough, allowing such kind of attachment work to be more convenient. In addition, the attached self-adhesive decorative material A can be air-dried naturally and is not easy to become wet through proper ventilation gaps existing in the foamed adhesive layer. Moreover, no size remains on a wall face after the decorative material is torn off therefrom, and the torn-off self-adhesive decorative material A can be used repeatedly.

Referring to FIG. 4, which is a perspective view of a self-adhesive decorative material A of the present invention, the thin film protection layer covered on the foamed adhesive layer 3 of a manufactured self-adhesive decorative material A can be torn off from the self-adhesive decorative material A, and the self-adhesive decorative material A can then be attached to a wall face through the foamed adhesive layer 3, allowing the attachment work to be more convenient. In addition, the self-adhesive decorative material can be detached from the wall face and reattached thereon again when the self-adhesive decorative material A on the wall looks skew or uneven.

Referring to FIG. 5, which shows a preferred embodiment of a manufacturing of a self-adhesive decorative material A according to the present invention, in the embodiment, a plant 5 is equipped with a size injecting unit 51, spatulas 52 and heating unit 53 in sequence, where a conveyor 54 is configured below the units mentioned above, allowing a roll of sheet substrate 1 such as wall cloth or wall paper to be fed through the conveyor 54. The sheet substrate 1 is first spread with size by the size injecting unit 51, the size is then wiped flat with the spatulas 52, allowing the size to maintain a proper uniform thickness, and the size is finally heated through the heating unit 53, allowing the size to be foamed to form a foamed adhesive layer 3.

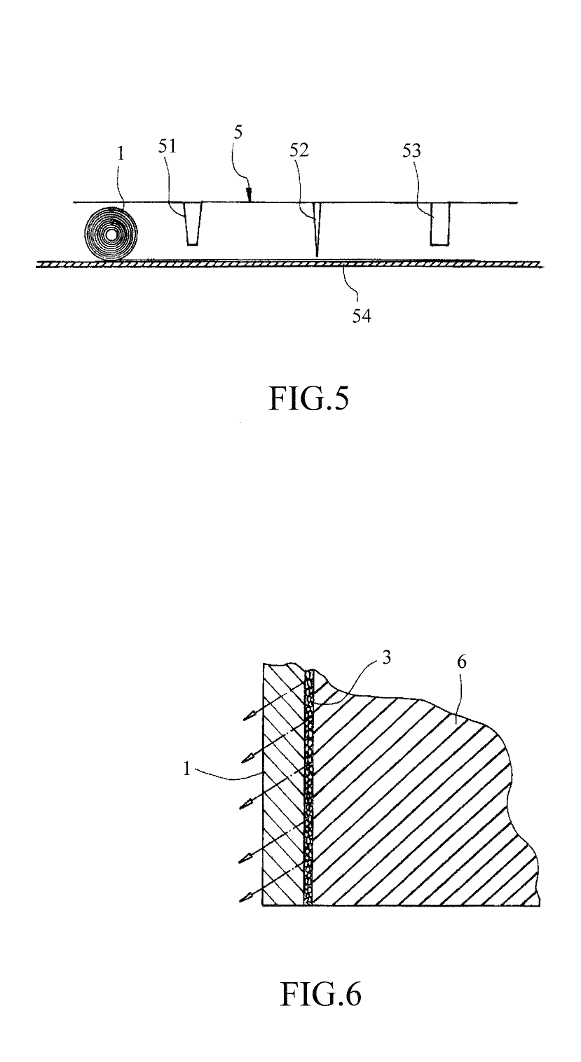

Referring to FIG. 6, which illustrates a state of attachment of a self-adhesive decorative material A to a wall face, the foamed adhesive layer 3 is positioned between the self-adhesive decorative material A and a wall face 6 after the self-adhesive decorative material A such as wall cloth or wall paper of the present invention is attached to the wall face 6. Ventilation is formed because of the existence of proper gaps in the foamed adhesive layer 3, thereby achieving the effects of natural air drying and difficulty to become wet, further increasing the use life of the self-adhesive decorative material A such as wall cloth or wall paper, and remaining no size on the wall face after the decorative material is torn off therefrom and allowing the torn-off self-adhesive decorative material A to be used repeatedly at some other time.

I claim:

1. A self-adhesive decorative material capable of attachment to a wall face, formed by the following steps: spreading chemical size on a sheet substrate such as wall cloth or wall paper, allowing said chemical size to form a foamed adhesive layer by means of mechanical foaming; and covering a thin film protection layer on said foamed adhesive layer, whereby, upon an attachment work, said self-adhesive decorative material is attached to a wall face after said thin film is torn off therefrom; a repeated attachment is possible while said attachment work is not good enough, allowing said attachment work to be more convenient; said attached self-adhesive decorative material is air-dried naturally and difficult to become wet through ventilation formed by proper gaps existing in said foamed adhesive layer; no size remains on said wall face after said self-adhesive decorative material is torn off therefrom; said torn-off self-adhesive decorative material may be used repeatedly; furthermore, customization is available for said self-adhesive decorative material or said self-adhesive decorative material can be cut into various shapes so as to attach to a wall face or an article by means of DIY mosaic.

2. The decorative material according to claim 1, wherein said chemical size is propyl acid resin.

3. The decorative material according to claim 1, wherein said chemical size is formed into said foamed adhesive layer by means of heating.
